(19) United States
(12) Patent Application Publication
(10) Pub. No.: US 2024/0380248 A1
(43) Pub. Date: Nov. 14, 2024

(54) Induction energy supply device

(71) Applicant: BSH Hausgeräte GmbH, Munich (DE)

(72) Inventors: Javier Lasobras Bernad, EJEA DE LOS CABALLEROS (ZARAGOZA) (ES); Sergio Llorente Gil, Zaragoza (ES); Jesus Manuel Moya Nogues, Zaragoza (ES); Jorge Pascual Aza, Zaragoza (ES); Javier Serrano Trullen, Zaragoza (ES); Jorge Tesa Betes, Zaragoza (ES)

(21) Appl. No.: 18/288,391

(22) PCT Filed: Apr. 27, 2022
(86) PCT No.: PCT/EP2022/061146

§ 371 Date: Oct. 26, 2023

(30) Foreign Application Priority Data
May 3, 2021 (EP) 21382392.5

(51) Int. Cl. H02J 50/12; H02J 50/40; H02J 50/60; H02J 50/80

(52) U.S. Cl. CPC H02J 50/12; H02J 50/402; H02J 50/60; H02J 50/80; H02J 2310/14

(57) ABSTRACT

An induction energy supply device includes a placeable unit, a supply unit having a supply induction element designed to inductively provide energy to the placeable unit, an inverter unit designed to drive the supply induction element, and a control unit designed to control the inverter unit and comprising a communication unit for wireless communication between the control unit and the placeable unit. The control unit is designed to interrupt an operation of the inverter unit at temporally repeating intervals during an interruption time window for the wireless communication.

The invention relates to an induction energy supply device according to the preamble of claim 1, and a method for operating an induction energy supply device according to the preamble of claim 13.

From the prior art there are known induction energy supply devices for inductive transmission of energy from a primary coil of a supply unit to a secondary coil of a placeable unit. For example, in the publication U.S. Pat. No. 3,761,668 A, an induction cooktop is proposed which, apart from an inductive heating of cooking equipment is also intended for an energy supply to small household appliances, for example, a mixer. Energy provided inductively by way of a primary coil of the induction cooktop is therein partially transmitted to a secondary coil integrated into the small household appliance.

Modern induction energy supply devices which are known from the prior art sometimes also have communication units for wireless communication between a control unit for controlling the supply unit and the placeable unit. A disadvantage of known solutions is that wireless communication signals partially interact with the alternating electromagnetic field of the supply unit, so that the wireless communication is disadvantageously interfered with and transmission errors can occur, so that an operating convenience to users is thereby reduced.

The object of the invention lies, in particular, in providing a generic device with improved properties with regard to an operating convenience, but is not restricted thereto. The object is achieved according to the invention by the features of claims 1 and 13, while advantageous embodiments and developments of the invention are disclosed in the subclaims.

The invention proceeds from an induction energy supply device having a supply unit. which has at least one supply induction element for the inductive provision of energy to a placeable unit, having an inverter unit for operating the supply induction element, with a control unit for controlling the inverter unit and having a communication unit for wireless communication between the control unit and the placeable unit.

It is proposed that the control unit is intended to interrupt an operation of the inverter unit in temporally repeating, in particular periodic, intervals during an interruption time window for the wireless communication.

With a design of this type, an induction energy supply device having a particularly high level of operating convenience can advantageously be provided. Advantageously, a particularly reliable wireless data transfer with a very low fault susceptibility can be enabled. In addition, an induction energy supply device can advantageously be provided with improved properties with regard to an electromagnetic compatibility. Furthermore, an induction energy supply device can advantageously be provided with a particularly broad power spectrum for supplying different placeable units with different power requirements if a duration of the interruption time window for reducing the inductively provided energy is extended by the control unit. Furthermore, a soft run-up and/or a soft run-down and thus a particularly gentle operation of the placeable unit can be enabled if the control unit drives the inverter unit at an adjusted frequency compared with a target power frequency during at least one transition time window. Therefore an induction energy supply device can be provided which, aside from a particularly high degree of operating convenience, is advantageously also distinguished by an excellent longevity and reliability.

The induction energy supply device also has at least one main functionality in the form of a wireless energy transmission, in particular a wireless energy supply to placeable units. The induction energy supply device can be configured as a part of an induction energy supply system. In an advantageous embodiment, the induction energy supply device is designed as an induction cooking device having at least one further main function deviating from a pure cooking function, in particular at least one energy supply to, and an operation of, small household appliances. For example, the induction energy supply device could be designed as an induction oven device and/or as an induction grill device. In particular, the supply unit could be designed as part of an induction oven and/or as part of an induction grill, Preferably, the induction energy supply device designed as an induction cooking device is designed as an induction cooktop. The supply unit is then designed, in particular, as part of an induction cooktop. In a further advantageous embodiment, the induction energy supply device is designed as a kitchen energy supply device and can also be intended, apart from a main function in the form of an energy supply and an operation of small household appliances, for providing cooking functions.

A “supply unit” should be understood to mean a unit which provides energy inductively in at least one operating state and which has, in particular, a main functionality in the form of an energy provision. For the provision of energy, the supply unit has at least one supply induction element which has, in particular, at least one coil, in particular at least one primary coil and/or is designed as a coil and which provides, in particular in the operating state, inductive energy. The supply unit could have at least two, in particular at least three, advantageously at least four, particularly advantageously at least five, preferably at least eight and particularly preferably a plurality of supply induction elements which could each provide inductive energy in the operating state, specifically in particular to a single absorbing induction element or to at least two or more absorbing induction elements of at least one placeable unit and/or at least one further placeable unit. At least a portion of the supply induction elements could be arranged in a vicinity of one another, for example, in a row and/or in the form of a matrix.

Preferably, in the operating state, the inverter unit carries out a frequency conversion and, in particular, converts an input-side low frequency alternating voltage into an output-side high frequency alternating voltage. Preferably, the low frequency alternating voltage has a frequency of not more than 100 Hz. Preferably, the high frequency alternating voltage has a frequency of at least 1000 Hz. The inverter unit is connected to the control unit and is able to be controlled by way of the control unit by means of control signals. Preferably, the inverter unit is intended to undertake the adjusting of the energy provided inductively by way of the at least one supply induction element by way of adjusting the high frequency alternating voltage. Preferably, the supply unit comprises at least one rectifier. Preferably, the inverter unit has at least one inverter switch element. Preferably, the inverter switch element for operation of the at least one supply induction element generates an oscillating electric current, preferably with a frequency of at least 15 kHz, in particular at least 17 kHz and advantageously at least 20 kHz. Preferably, the inverter unit comprises at least two inverter switch elements which are preferably designed as bipolar transistors with an insulated gate electrode and particularly advantageously at least one damping capacitor.

A “placeable unit” should be understood to mean a unit which receives inductive energy in at least one operating state and which converts inductively received energy at least partially into at least one further form of energy for providing at least one main function. For example, the inductively received energy could be converted, in particular directly, by the placeable unit in the operating state into at least one further energy form, for example, into heat. Alternatively or additionally, the placeable unit can have at least one electrical consumer, for example, an electric motor or suchlike. The placeable unit has at least one absorbing induction element for receiving the inductively provided energy. The placeable unit could have, for example, at least two, in particular at least three, advantageously at least four, particularly advantageously at least five, preferably at least eight and particularly preferably a plurality of absorbing induction elements which could each receive inductive energy, in particular in the operating state, in particular from the supply induction element. The placeable unit could be designed, for example, as a cooking equipment item. The cooking equipment item preferably has at least one food receptacle and converts the inductively received energy in the operating state at least partially into heat for heating food items arranged in the food receptacle. Preferably, the placeable unit designed as a cooking equipment item has at least one further unit for providing at least one further function which extends beyond a pure heating of food items and/or deviates from a heating of food items. For example, the further unit could be designed as a temperature sensor or as a stirring unit or suchlike. Alternatively, the placeable unit can be configured as a small household appliance. Preferably, the small household appliance is a non-stationary household appliance which has at least the absorbing induction element and at least one functional unit which, in an operating state, provides at least one household appliance function. “Non-stationary” should be understood in this context to mean that the small household appliance is able to be positioned freely by a user in a household and, in particular, without any aids, in particular, as distinct from a large household appliance which is fixedly positioned and/or installed at a particular position in a household, for example, an oven or a refrigerator. Preferably. the small household appliance is designed as a small kitchen appliance and, in the operating state, provides at least one main function for the processing of food items. The small household appliance could be designed, for example, as a food processor and/or as a mixer and/or as a stirrer and/or as a grinder and/or as a kitchen weighing scale or as a water boiler or as a coffee machine or as a rice cooker or as a milk frother or as a deep fryer or as a toaster or as a juicer or as a cutting machine or suchlike, but without being restricted thereto.

The absorbing induction element of the placeable unit comprises at least one secondary coil and/or is designed as a secondary coil. In an operating state of the placeable unit, the absorbing induction element supplies at least one consumer of the placeable unit with electrical energy. It is further conceivable that the placeable unit has an energy store, in particular an accumulator, which is intended to store electrical energy received via the absorbing induction element in a charging state and, in a discharging state, to provide it for the supply of the functional unit.

Preferably, the induction energy supply device has at least one placement panel for placing the placeable unit. A “placement panel” should be understood to mean an, in particular, panel-like unit which is intended for a placement of at least one placeable unit and/or for placing at least one cooking object. The placement panel could be designed, for example, as a worktop, in particular as a kitchen worktop or as a portion of at least one worktop, in particular of at least one kitchen worktop, in particular of the induction energy supply device. Alternatively or additionally, the placement panel could be designed as a cooktop panel. The placement panel designed as a cooktop panel could, in particular, form at least a part of a cooktop outer housing and, in particular, together with at least one outer housing unit to which the placement panel designed as a cooktop panel, could, in particular. be connected in at least one mounted state, could at least largely form the cooktop outer housing. Preferably, the placement panel is made of a non-metallic material. The placement panel could be formed at least largely of glass and/or glass ceramics and/or of Neolith and/or of Dekton and/or of wood and/or of marble and/or of stone, in particular natural stone, and/or of laminated material and/or of plastics and/or of ceramics. In the present application, positional references such as “beneath” or “above” relate to a mounted state of the placement panel, provided this is not explicitly described otherwise. In the mounted state, the supply unit is preferably arranged beneath the placement panel.

A “control unit” should be understood to mean an electronic unit which is intended to control and/or regulate at least the inverter unit. Preferably, the control unit comprises a computing unit and, in particular, in addition to the computing unit, a storage unit having a control and/or regulating program stored therein which is intended to be executed by the computing unit.

The communication unit is preferably intended for a bidirectional wireless data transfer, that is, both for a wireless reception and also for a wireless transmission of data. Preferably, the communication unit has at least one communication element which is connected to the control unit and is intended, in particular, for a wireless reception and transmission of data. Preferably, the communication unit has at least one further communication element which is arranged within the placeable unit and is intended, in particular, for a wireless reception and transmission of data. The communication unit could be intended for a wireless data transfer between the placeable unit and the control unit via RFID or via Wi-Fi or via Bluetooth or via ZigBee or for wireless data transfer according to another suitable standard. Preferably, the communication unit is intended for a wireless data transfer between the placeable unit and the control unit via NFC.

Preferably, the control unit is intended to interrupt the operation of the inverter unit such that at least one inverter switch element of the inverter unit which, for the operation of the supply induction element, provides the inductive energy to the placeable unit during at least one time window outside the interruption time window, is not supplied during the interruption time window with an input-side low-frequency alternating voltage. It is conceivable, in particular, that the control unit is intended to operate at least one further inverter switch element of the inverter unit which is intended for the inductive provision of energy to a further placeable unit during the interruption time window. The control unit could be intended to interrupt the operation of the inverter unit at temporally irregularly repeating intervals, for example during at least three interruption time windows temporally spaced irregularly from one another within a control period. Preferably, the control unit is intended to interrupt the inverter unit at regular, in particular periodically repeating intervals, for example at intervals which correspond to a fraction or a multiple of a period duration of a mains alternating voltage during the interruption time window.

“Intended” should be understood, in particular, as especially programmed, designed and/or equipped. That an object is intended for a particular function should be understood as meaning that the object fulfils and/or carries out this particular function in at least one usage and/or operating state.

It is further proposed that a duration of the interruption time window is at least 1.0 ms. By this means, an operating convenience can advantageously be further improved. In particular, a reliable and fault-free wireless communication can be achieved. Advantageously. the duration of the interruption time window is at least 1.25 ms, advantageously preferably at least 1.5 ms, preferably at least 1.75 ms and particularly preferably at least 2.0 ms. The duration of the interruption time window could be not more than 1.5 ms. Advantageously, the duration of the interruption time window is not more than 2 ms, advantageously not more than 3 ms, preferably not more than 4 ms and particularly preferably not more than 5 ms. Preferably. the duration of the interruption time window corresponds to no more than a quarter of a period duration of an alternating mains voltage with which the induction energy supply device is supplied in an operating state.

In addition, it is proposed that the control unit is intended to extend a duration of the interruption time window to reduce the inductively provided energy. By this means, an operating convenience can advantageously be further improved. In particular, an induction energy supply device can advantageously be provided with a particularly broad power spectrum for supplying different placeable units with different power requirements if a duration of the interruption time window for reducing the inductively provided energy is extended by the control unit. Preferably, the control unit is intended to extend the duration of the time window for reducing the energy inductively provided by the supply unit, in particular by way of the supply induction element of the supply unit, such that thereby a mean power level of the energy inductively received by way of the placeable unit, in particular by way of the absorbing induction element of the placeable unit is reduced. In particular, the control unit is intended to extend the duration of the interruption time window for the reduction of the inductively provided energy by at least 1.0 ms, advantageously by at least 1.5 ms, particularly advantageously by at least 2.0 ms. preferably by at least 2.5 ms and particularly preferably by at least 3.0 ms.

It is further proposed that the control unit is intended to space successive interruption time windows temporally by at least a half period duration of a mains alternating voltage. By this means, an operating convenience can advantageously be further improved. It can be ensured, in particular, that the inverter unit is supplied at least temporarily with energy for an operation of the supply induction element within a period duration of the mains alternating voltage, so that a mean power level of the energy provided inductively to the placeable unit, in particular over a period lasting a plurality of period durations of the mains alternating voltage, corresponds at least to a minimum power level of the placeable unit. Preferably, the control unit is intended to temporally space successive interruption time windows by whole number multiples of the half period duration of the mains alternating voltage.

It is further proposed that the control unit is intended to operate the inverter unit during at least one transition time window at an adjusted frequency compared with a target power frequency. By this means, an operating convenience can advantageously be further improved. Advantageously, a soft run-up and/or soft run-down of the placeable unit and thus a particularly gentle operation of the placeable unit can be enabled. Thus, a longevity of the placeable unit can advantageously be improved. The transition time window preferably represents a transition between two states of the inverter, specifically a transition between one state in which an operation of the inverter unit is interrupted and a state in which an operation of the inverter unit is interrupted and a state in which the inverter unit is operated at the target power frequency. The target power frequency therein preferably corresponds to a frequency at which the control unit must operate the inverter unit so that a portion of the power provided inductively by the supply induction element that is received by the absorbing induction element corresponds to a target power level of a currently set power level of the placeable unit. A value of the frequency adjusted relative to the target power frequency deviates from the target power frequency in particular by at least 5%, advantageously by at least 7.5%, particularly advantageously by at least 10%, preferably by at least 12.5% and particularly preferably by at least 15%. Preferably, the control unit is intended to operate the inverter unit at mms least one time point within the transition time window at a frequency adjusted maximally relative to the target power frequency and at mms least one further time point within the transition time window at a frequency that is minimally adjusted in relation to the target power frequency. Preferably, the control unit is intended to vary the frequency at which the inverter unit is operated in the transition time window such that an, in particular, at least substantially stepless transition between the frequency maximally adjusted in relation to the target power frequency and the frequency minimally adjusted in relation to the target power frequency is achieved. Depending upon the operating mode with which the control unit operates the inverter unit value of the frequency adjusted in relation to the target power frequency can be larger or smaller than a value of the target power frequency.

Preferably. the control unit is intended to operate the inverter unit in a zero voltage switching (ZVS) mode, wherein a value of the frequency adjusted in relation to the target power frequency is greater than an amount of the target power frequency, so that the proportion of the mean power provided inductively by way of the supply induction element within the transition time window that is received by the absorbing induction element is smaller than the target power of a currently set power level of the placeable unit. Alternatively or additionally, it is also conceivable that the control unit could be intended to operate the inverter unit in a zero current switching (ZCS) mode wherein a value of the frequency adjusted in relation to the target power frequency is preferably smaller than a value of the target power frequency, so that the proportion of the mean power provided inductively by way of the supply induction element within the transition time window that is received by the absorbing induction element during the transition time window is smaller than the target power of a currently set power level of the placeable unit.

It is further proposed that the control unit is intended to arrange the transition time window and the interruption time window temporally immediately adjoining one another. By this means, an operating convenience can advantageously be further improved. Advantageously, a particularly gentle operation of the placeable unit can be enabled. In an operating state, the control unit could arrange the transition time window immediately following the interruption time window. By this means, advantageously soft run-up of the placeable unit can be enabled. In the operating state, the control unit could alternatively or additionally arrange the transition time window temporally immediately preceding the interruption time window. By this means, advantageously, a soft run-down of the placeable unit can be enabled.

It is further proposed that a duration of the transition time window is at least a duration of the interruption time window. By this means, an operating convenience can advantageously be further improved. In particular, a precise adaptation of the frequency between the frequency adjusted in relation to a target power frequency, and the target power frequency and therefore a particularly gentle operation of the placeable unit, can be enabled. It is further proposed that a duration of the transition time window is not more than a half period duration of a mains alternating voltage. With an embodiment of this type, an operating convenience can advantageously be further improved. In particular, a transition time window can be created which, firstly, lasts sufficiently long to enable a precise adaptation of the frequency between the frequency adjusted in relation to a target power frequency and the target power frequency and, secondly, enables a rapid start-up of the placeable unit. Preferably, the duration of the transition time window is not more than a quarter of the period duration of the mains alternating voltage.

It is further proposed that the control unit is intended to carry out at least one further operation during the interruption time window besides an interaction with the communication unit. By this means, an operating convenience can advantageously be further improved. In the interruption time window, the control unit carries out a first operation in the form of an interaction with the communication unit. The interaction of the control unit with the communication unit can comprise an exchange and a processing of data, for example operating parameters of the placeable unit which are received by means of the communication unit from the placeable unit and are passed on to the control unit, and/or operating parameters of the supply unit which are transmitted by the control unit via the communication unit to the placeable unit, but without being restricted thereto. The further operation that the control unit carries out during the interruption time window could be for example an interaction with a user, for example the output of current information items relating to an operating state, regarding an input and output unit connected to the control unit and/or the recording and processing of operating commands from the user input by the user via an input and output unit, but without being restricted thereto. In addition, the further operation could be a computing operation, for example, a calculation of a power curve of a supply induction element of the supply unit, in particular on the basis of the operating parameters of the placeable unit received by the communication unit.

It is further proposed that the further operation comprises a detection of, in particular metallic, foreign objects in a near region of the supply induction element. By this means, an operating convenience can advantageously be further enhanced. In addition, an operating reliability for a user is increased and the danger of damage to components of the induction energy supply device can be minimized. For the detection of foreign objects, the control unit could bring at least one further inverter switch element of the inverter unit, which is intended for an operation of a further supply induction element and which is different from the inverter switch element for supplying the supply induction element, the operation of which is interrupted during the interrupting time period, into operation by means of a detection signal. In the event that a metal foreign object, for example a metal implement is situated on the placement panel in the vicinity between the supply induction element and the further supply induction element resonance frequency of an electrical oscillator circuit which comprises the further inverter switch element and the further supply induction element, changes in relation to a reference value stored in the storage unit of the control unit and therefrom the control unit detects the presence of the foreign object. Alternatively or additionally, it would be conceivable that the detection of foreign objects could be undertaken optically, for example by means of a camera of the induction energy supply device, said camera being connected to the control unit.

In a further advantageous embodiment, it is proposed that the induction energy supply device has the placeable unit, which is configured as a small household appliance. By this means, an induction energy supply device can be provided with a particularly high degree of functionality and flexibility.

In an alternative advantageous embodiment, it is proposed that the induction energy supply device has the placeable unit, which is configured as a cooking equipment item. By this means, an induction energy supply device can advantageously be made available with a particularly high level of operating convenience, in particular with regard to a precise control of an energy provided inductively by way of the supply unit, for heating food items arranged in the cooking equipment.

The invention further proceeds from a method for operating an induction energy supply device, in particular according to one of the embodiments described above, having a supply unit, which has at least one supply induction element for the inductive provision of energy to a placeable unit, and having an inverter unit for driving the supply induction element, and having a communication unit for wireless communication with the placeable unit.

It is proposed that an operation of the inverter unit is interrupted at regular intervals during a time window for the wireless communication. By way of such a method, a particularly user-friendly, convenient and relatively fault-free operation of the induction energy supply device can advantageously be achieved, in particular with regard to a wireless communication between the control unit and the placeable unit.

The induction energy supply device should not thereby be restricted to the use and embodiment described above. In particular, the induction energy supply device can have, for a fulfillment of a functional method described herein, a number of individual elements, components and units deviating from a number mentioned herein.

Further advantages are revealed in the following description of the drawings. The drawings show two exemplary embodiments of the invention. The drawings, the description and the claims contain numerous features in combination. A person skilled in the art would also suitably consider the features individually and group them into further useful combinations.

In the drawings:

FIG. 1 shows an induction energy supply device having a supply unit, a control unit, a communication unit, a placeable unit and a further placeable unit in a schematic representation,

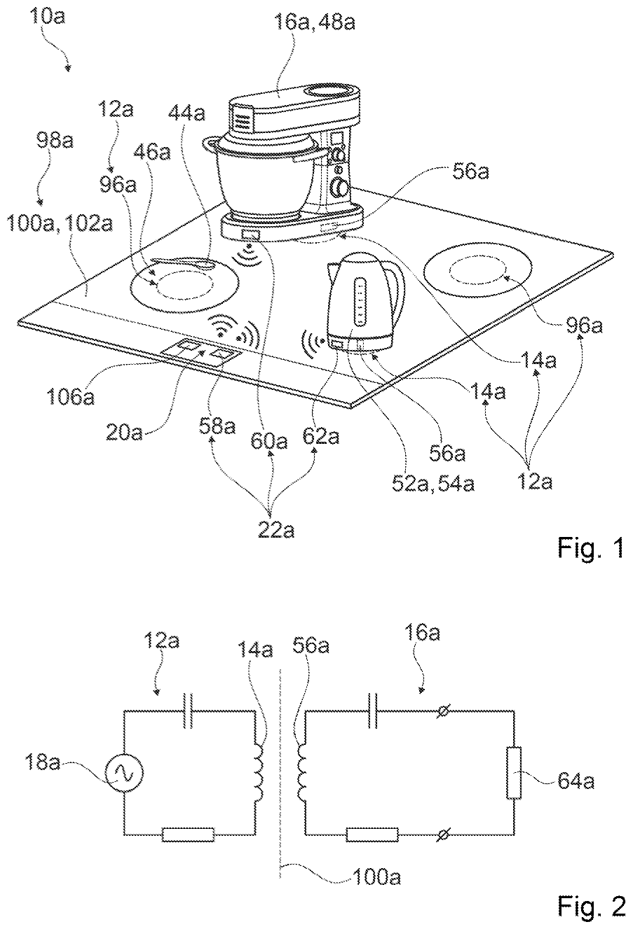

FIG. 2 shows a schematic equivalent electrical circuit diagram to represent an inductive energy transmission between a supply induction element of the supply unit which is driven by an inverter unit, and an absorbing induction element of the placeable unit,

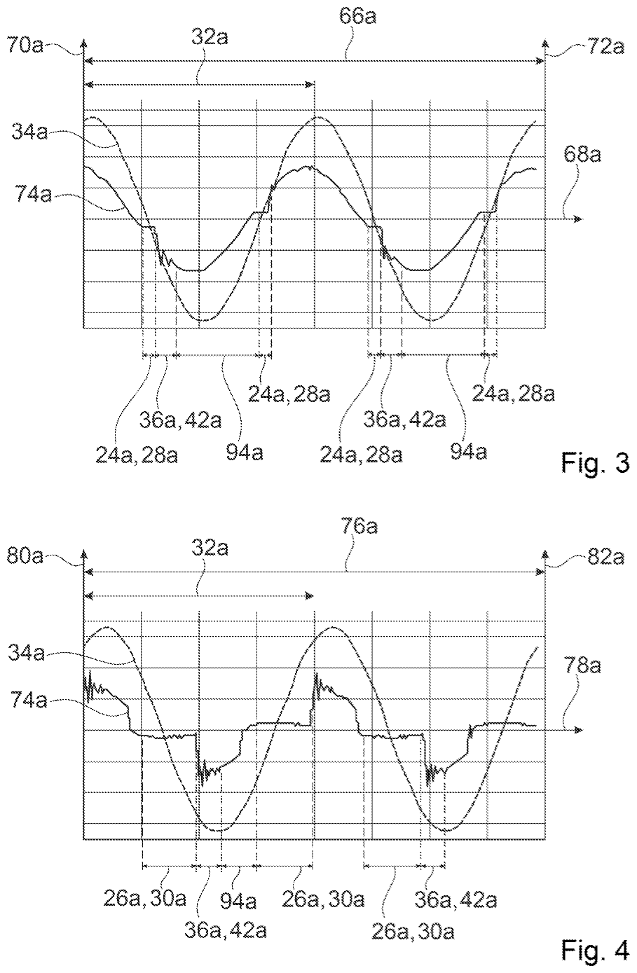

FIG. 3 shows a schematic diagram to illustrate a variation over time of an alternating current with which the inverter unit drives the supply induction element in a first control period,

FIG. 4 shows a schematic diagram to illustrate a variation over time of an alternating current with which the inverter unit drives the supply induction element in a second control period,

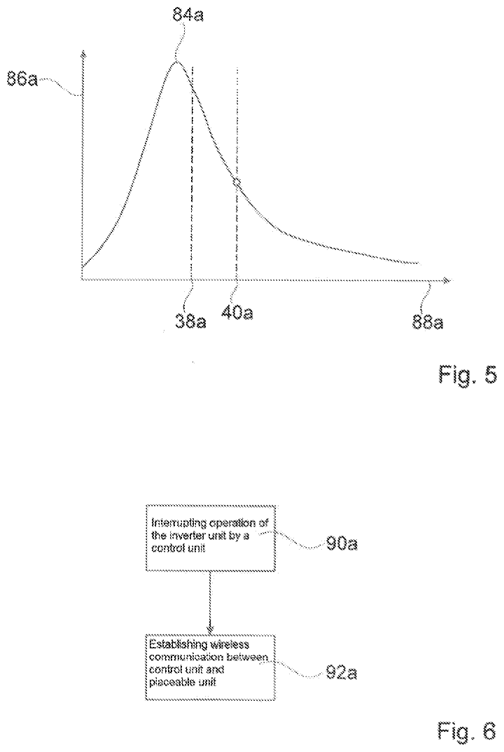

FIG. 5 shows a schematic diagram to illustrate a power curve of the supply induction element of the supply unit,

FIG. 6 shows a schematic diagram to illustrate a method for operating the induction energy supply device, and

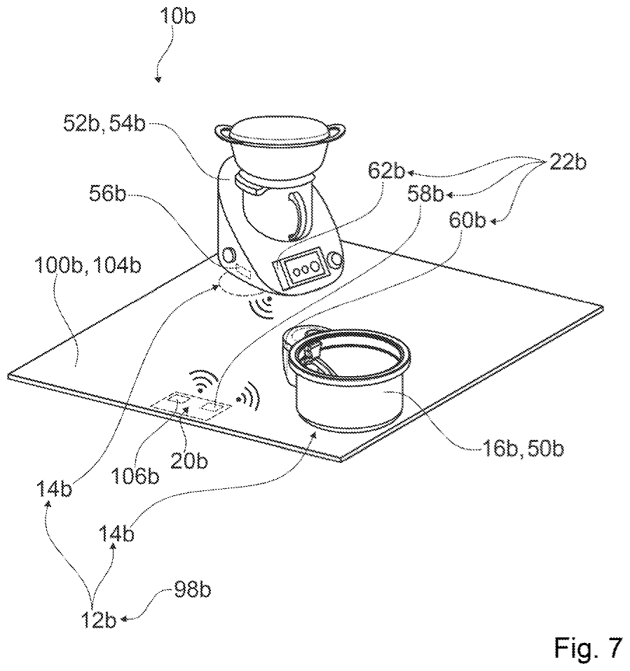

FIG. 7 shows a further exemplary embodiment of an induction energy supply device with a supply unit, a control unit of a placeable unit and a further placeable unit in a schematic representation.

FIG. 1 shows an induction energy supply device 10a in a schematic representation. The induction energy supply device 10a has a supply unit 12a. The supply unit 14a has at least one supply induction element 14a for the inductive provision of energy. In the present case, the supply unit 12a comprises in total four supply induction elements, specifically three supply induction elements 14a and two further supply induction elements 96a, wherein any other desired number would also be conceivable.

The induction energy supply device 10a has a placeable unit 16a. The placeable unit 16a is designed as a small household appliance 48a, specifically as a food processor. The placeable unit 16a has an absorbing induction element 56a for reception of at least part of the energy provided inductively by way of the supply unit 12a. The induction energy supply device 10a has a further placeable unit 52a. The further placeable unit 52a is designed as a further small household appliance 54a, specifically as a water boiler. The further placeable unit 52a also has an absorbing induction element 56a for reception of at least part of the energy provided inductively by way of the supply unit 12a.

In the present case, the induction energy supply device 10a comprises an induction cooktop 98a. The induction energy supply device 10a has a placement panel 100a. In the present case, the placement panel 100a is designed as a cooktop panel 102a of the induction cooktop 98a. The placement panel 100a is intended for placement of the placeable unit 16a and the further placeable unit 52a.

The induction energy supply device 10a has an inverter unit 18a (see FIG. 2). The inverter unit 18a is intended for operation of the supply induction elements 14a and for operation of the further supply induction elements 96a and comprises a plurality of inverter switch elements (not shown) which are designed as bipolar transistors with an insulated gate electrode (IGBT).

The induction energy supply device 10a has a control unit 20a for controlling the inverter unit 18a. The control unit 20a is electrically conductively connected to the inverter unit 18a. In an operating state of the induction energy supply device 10a, the control unit 20a controls the inverter unit 18a by means of control signals. The control unit 20a comprises a storage unit 106a in which, inter alia, operating parameters of the supply unit 12a, for example inductances of the supply induction elements 14a, are stored.

The induction energy supply device 10a has a communication unit 22a. The communication unit 22a is intended for a wireless communication between the control unit 20a and the placeable unit 16a. The communication unit 22a is also intended for a wireless communication between the control unit 20a and the further placeable unit 52a. The communication unit 22a has a communication element 58a which is connected to the control unit 20a and is intended for a wireless transmission and reception of data. The communication unit 22a has a further communication element 60a which is arranged in the placeable unit 16a and is intended for a wireless transmission and reception of data. The communication unit 22a also has a further communication element 62a which is arranged in the further placeable unit 52a and is intended for a wireless transmission and reception of data. In the present case, the communication unit 22a is designed as an NFC communication unit and is intended for a wireless communication via NFC between the control unit 20a and the placeable unit 16a and/or the further placeable unit 52a.

FIG. 2 shows a schematic equivalent electrical circuit diagram to illustrate an inductive energy transmission between the supply induction element 14a of the supply unit 12a and the absorbing induction element 56a of the placeable unit 16a. In the operating state of the induction energy supply device 10a, the inverter unit 18a supplies the supply induction element 14a with an alternating current 74a (see FIGS. 3 and 4) for the inductive provision of energy.

In the operating state, the control unit 20a controls the energy provided inductively by way of the supply induction element 14a by means of an adjustment of a frequency of the alternating current 74a provided by way of the inverter unit 18a. In the operating state, the supply induction element 14a generates an alternating electromagnetic field by way of which the energy is provided inductively. In the operating state, the absorbing induction element 56a is arranged at a spacing from the supply induction element 14a. In the operating state, a magnetic flux of the alternating electromagnetic field that is generated by way of the supply induction element 14a, is at least partially coupled into the absorbing induction element 56a, so that an alternating voltage is induced in the absorbing induction element 56a and so at least part of the inductively provided energy is received. The placeable unit 16a has at least one electrical load 64a. The electrical load 64a represents an electrical consumer of the placeable unit 16a which is supplied in the operating state, in order to provide at least one function of the placeable unit 16a, with the alternating voltage induced in the absorbing induction element 56a.

FIG. 3 shows a schematic diagram of a first control period 66a of a control of the inverter unit 18a by the control unit 20a. Indicated on an abscissa 68a of the graph is time in milliseconds. Indicated on a first ordinate 70a of the graph is a value of the alternating current 74a in ampere. Indicated on a second ordinate 72a of the graph is a value of a mains alternating voltage 34a of a power supply network (not shown) to which, in the operating state, the induction energy supply device 10a is connected.

The control unit 20a is intended to interrupt an operation of the inverter unit 18a in temporally repeating, in particular periodic, intervals during an interruption time window 24a for the wireless communication between the control unit 20a and the placeable unit 16a. During the interruption time window 24a, the supply induction element 14a is not supplied with the alternating current 74a or the value of the alternating current 74a is 0 ampere. A duration 28a of the interruption time window 24a is at least 1.0 millisecond. The duration 28a of the interruption time window 22a in the present case is 1.5 milliseconds.

The control unit 20a is intended to space successive interruption time windows 24a temporally by at least a half period duration 32a of the mains alternating voltage 34a. A mains frequency of the mains alternating voltage 34a in the present case is 50 hertz. The period duration 32a of the mains alternating voltage 34a is therefore 20 milliseconds. In the present case, the control unit 20a spaces the successive interruption time windows 24a within the control period 66a by exactly one half period duration 32a. The interruption time windows 24a are therefore spaced from one another within the control period 66a by exactly 10 milliseconds. In the present case, the control period 66a lasts at least two period durations 32a, that is, at least 40 milliseconds.

FIG. 4 shows a schematic diagram of a second control period 76a of a control of the inverter unit 18a by the control unit 20a. The second control period 76a temporally adjoins the first control period 66a (see FIG. 3). Indicated on an abscissa 78a of the graph is time in milliseconds. Indicated on a first ordinate 80a of the graph is a value of the alternating current 74a in ampere. Indicated on a second ordinate 82a of the graph is a value of the mains alternating voltage 34a of the power supply network (not shown) to which, in the operating state, the induction energy supply device 10a is connected.

The control unit 20a is intended to interrupt an operation of the inverter unit 18a in temporally repeating, in particular periodic, intervals during an interruption time window 26a for the wireless communication between the control unit 20a and the placeable unit 16a. During the interruption time window 26a, the supply induction element 14a is not supplied with the alternating current 74a and/or the value of the alternating current 74a is 0 ampere. A duration 30a of the interruption time window 26a is at least 1.0 millisecond. The control unit 20a is intended to extend the duration 30a of the interruption time window 26a for reducing the energy provided inductively by way of the supply induction element 14a. In the present case, the control unit 20a extends the duration 30a of the interruption time window 26a within the second control period 76a, as compared with the interruption time window 24a of the first control period 66a (see FIG. 3), by 3.5 milliseconds. The duration 30a of the interruption time window 26a amounts altogether to 5 milliseconds, which represents a quarter of the period duration 32a of the mains alternating voltage 34a. By this means, a mean power of the energy provided inductively within the second control period 76a by way of the supply induction element 14a is significantly reduced as compared with a mean power within the first control period 66a.

The control unit 20a is intended to carry out at least one operation during the interruption time window 24a (see FIG. 3) and/or during the interruption time window 26a (see FIG. 4). In the present case, an operation which the control unit 20a carries out during the interruption time window 24a and/or during the interruption time window 26a is an interaction with the communication unit 22a. During the interruption time window 24a, 26a, the control unit 20a processes data, for example operating parameters of the placeable unit 16a and/or of the further placeable unit 52a, that have been received via the communication unit 22a from the placeable unit 16a and/or have been received from the further placeable unit 52a and/or data, for example operating parameters of the supply unit 12a which are to be transmitted via the communication unit 22a to the placeable unit 16a and/or to the further placeable unit 52a. In the present case, the control unit 20a is intended to carry out at least one further operation during the interruption time window 24a, 26a besides the interaction with the communication unit 22a. In the present case, the further operation comprises a detection of foreign objects 44a in a vicinity 46a of the supply induction element 14a (see FIG. 1). For the detection of a foreign object 40a, for example, a metal fork represented in FIG. 1 as a foreign object 44a, during the interruption time window 24a, the control unit 20a drives the inverter unit 18a to a brief operation of the further supply induction element 96a. If a foreign object 44a is positioned on the placement panel 100a in the vicinity 46a between the supply induction element 14a and the further supply induction element 96a, at least one parameter, for example a resonance frequency of an oscillator (not shown) of the supply unit 12a which comprises the further supply induction element 12a which comprises the further supply induction element 96a, becomes adjusted relative to a reference parameter stored in the storage unit 106a and the presence of the foreign object 44a is detected by the control unit 20a.

FIG. 5 shows a schematic diagram to illustrate a power curve 84a of the supply induction element 14a of the supply unit 12a. Indicated on an ordinate 86a of the graph is a power in watts. Indicated on an abscissa 88a is a frequency in kilohertz of the alternating current 74a. The power of the energy provided inductively by way of the supply induction element 14a varies dependent upon the frequency of the alternating current 74a.

The control unit 20a is intended to operate the inverter unit 18a during at least one transition time window 36a (see FIG. 3) at an adjusted frequency 40a compared with a target power frequency 38a. In the present case, the control unit 20a operates the inverter unit 18a, in the operating state, in a zero voltage switching mode. In the present case, the adjusted frequency 40a has a larger value than the target power frequency 38a, wherein in an operation of the inverter unit 18a at the adjusted frequency 40a, a power level provided inductively by way of the supply induction element 14a is lower than an inductively provided power level in an operation of the inverter unit 18a at the target power frequency. In the operation of the inverter unit 18a at the target power frequency 38a, a proportion of the inductively provided power of the supply induction element 14a which is absorbed by the absorbing induction element 56a of the placeable unit 16a corresponds to a target power level for providing a currently set function of the placeable unit 16a.

The control unit 20a is intended to arrange the transition time window 36a and the interruption time window 24a temporally immediately adjoining one another. In the present case, in the operating state, the control unit 20a arranges the transition time window 36a temporally immediately following the interruption time window 24a. In the present case, the transition time window 36a serves to provide a soft run-up of the placeable unit 16a. In the operating state, the control unit 20a controls the inverter unit 18a at the start of the transition time window 36a for operation at the adjusted frequency 40a, in order to limit the power provided inductively by way of the supply induction element 14a and to enable the soft run-up of the placeable unit 16a. During a temporal duration of the transition time window 36a, the control unit 20a reduces a value of the frequency of the alternating current 74a provided by the inverter unit 18a from the value of the adjusted frequency 40a to a value that is only insubstantially higher than the value of the target power frequency 38a. During a target power time window 94a which temporally directly adjoins the transition time window 36a, the control unit 20a drives the inverter unit 18a to an operation at the target power frequency 38a.

Alternatively or additionally, it would also be conceivable that the transition time window 36a is intended to provide a soft run-down of the placeable unit 16a. For this purpose, the control unit 20a would arrange the transition time window 36a temporally directly following the target power time window 94a and would control the value of the frequency of the alternating current 74a provided by the inverter unit 18a within the transition time window 36a starting from the value that is only insubstantially higher than the value of the target power frequency 38a rising to the value of the adjusted frequency 94a. In this case, the transition time window 36a would be arranged temporally directly before the interruption time window 24a and the control unit 20a would interrupt the operation of the inverter unit 18a starting from the adjusted frequency 94a at the end of the transition time window 36a at the start of the interruption time window 24a.

A duration 42a of the transition time window 36a corresponds to at least the duration 28a of the interruption time window 24a. The duration 42a of the transition time window 36a corresponds to no more than a half period duration 32a of the mains alternating voltage 32a. In the case of a mains frequency of 50 hertz, the duration 42a of the transition time window 36a is therefore not more than 10 milliseconds. In the present case, the duration 38a is exactly the duration 28a of the interruption time window 24a and is 1.5 milliseconds.

FIG. 6 shows a schematic diagram to illustrate a method for operating the induction energy supply device 10a. In the method, an operation of the inverter unit 18a is interrupted at regular intervals during an interruption time window 24a, 26a for the wireless communication. The method comprises at least two method steps. In a first method step 90a, the operation of the inverter unit 18a is interrupted by the control unit 20a. In a second method step 92a. the wireless communication between the control unit 20a and the placeable unit 16a takes place, specifically by means of the communication unit 22a.

FIG. 7 shows a further exemplary embodiment of the invention. The following descriptions are essentially restricted to the differences between the exemplary embodiments. wherein with regard to components, features and functions which remain the same, reference can be made to the description of the exemplary embodiment in FIGS. 1 to 6. In order to differentiate the exemplary embodiments, the letter a in the reference characters of the exemplary embodiment of FIGS. 1 to 6 is replaced by the letter b in the reference characters of the exemplary embodiment of FIG. 7. With regard to components that are identified identically, in particular with regard to components with the same reference characters, in principle, reference can be made to the drawings and/or the description of the exemplary embodiment of FIGS. 1 to 7.

FIG. 7 shows an induction energy supply device 10b in a schematic representation. The induction energy supply device 10b has a supply unit 12b. The supply unit 12b has at least one supply induction element 14b for the inductive provision of energy. In the present case, the supply unit 12b comprises in total two supply induction elements 14b, although any other desired number is conceivable.

The induction energy supply device 10b has a placeable unit 16b. As distinct from the previous exemplary embodiment. the placeable unit 16b is designed as a cooking equipment item 50b. The placeable unit 16b has an absorbing induction element 56b for receiving at least part of the energy provided inductively by way of the supply unit 12b. The induction energy supply device 10b has a further placeable unit 52b. The further placeable unit 52b is designed as a small household appliance 54b, specifically as a food processor. The further placeable unit 52b also has an absorbing induction element 56b for reception of at least part of the energy provided inductively by way of the supply unit 12b.

In the present case, the induction energy supply device 10b comprises an induction cooktop 98b which, as distinct from the induction cooktop 98a of the previous exemplary embodiment, is designed as an invisible induction cooktop 98b. The induction energy supply device 10b has a placement panel 100b. As distinct from the previous exemplary embodiment, the placement panel 100b is designed as a kitchen worktop 104b and not as part of the induction cooktop 98b. The placement panel 100b is intended for placement of the placement unit 16b and the further placeable unit 52b.

The induction energy supply device 10a has an inverter unit (not shown). The inverter unit is intended for an operation of the supply induction elements 14a and comprises a plurality of inverter switch elements (not shown) which are designed as bipolar transistors with an insulated gate electrode (IGBT).

The induction energy supply device 10b has a control unit 20b for controlling the inverter unit. The control unit 20b is intended to interrupt an operation of the inverter unit in temporally repeating, in particular periodic, intervals during an interruption time window (not shown) for the wireless communication. With regard to a mode of operation of the control unit 20b, reference can be made to the description above regarding the mode of operation of the control unit 20a of the above-described exemplary embodiment of FIGS. 1 to 6.

### REFERENCE CHARACTERS

10 Induction energy supply device

12 Supply unit

14 Supply induction element

16 Placeable unit

18 Inverter unit

20 Control unit

22 Communication unit

24 Interruption time window

26 Interruption time window

28 Duration

30 Duration

32 Period duration

34 Mains alternating voltage

36 Transition time window

38 Target power frequency

40 Adjusted frequency

42 Duration

44 Foreign object

46 Vicinity

48 Small household appliance

50 Cooking equipment

52 Further placeable unit

54 Further small household appliance

56 Absorbing induction element

58 Communication element

60 Further communication element

62 Further communication element

64 Electrical load

66 First control period

68 Abscissa

70 First ordinate

72 Second ordinate

74 Alternating current

76 Second control period

78 Abscissa

80 First ordinate

82 Second ordinate

84 Power curve

86 Ordinate

88 Abscissa

90 First method step

92 Second method step

94 Target power time window

96 Further supply induction element

98 Induction cooktop

100 Placement panel

102 Cooktop panel

104 Kitchen worktop

106 Storage unit

1-13 (canceled)

14. An induction energy supply device, comprising:
a placeable unit;
a supply unit comprising a supply induction element designed to inductively provide energy to the placeable unit;
an inverter unit designed to drive the supply induction element;
a control unit designed to control the inverter unit and comprising a communication unit for wireless communication between the control unit and the placeable unit, said control unit designed to interrupt an operation of the inverter unit at temporally repeating intervals during an interruption time window for the wireless communication.

15. The induction energy supply device of claim 14, wherein the control unit is designed to interrupt the operation of the inverter unit at periodic intervals during the interruption time window for the wireless communication.

16. The induction energy supply device of claim 14, wherein a duration of the interruption time window is at least 1.0 ms.

17. The induction energy supply device of claim 14, wherein the control unit is designed to extend a duration of the interruption time window for reducing the inductively provided energy.

18. The induction energy supply device of claim 14, wherein the control unit is designed to space successive interruption time windows temporally by at least a half period duration of a mains alternating voltage.

19. The induction energy supply device of claim 14, wherein the control unit is designed to operate the inverter unit during a transition time window at an adjusted frequency compared with a target power frequency.

20. The induction energy supply device of claim 19, wherein the control unit is designed to arrange the transition time window and the interruption time window temporally immediately adjoining one another.

21. The induction energy supply device of claim 19, wherein a duration of the transition time window corresponds to at least one duration of the interruption time window.

22. The induction energy supply device of claim 19, wherein a duration of the transition time window corresponds to not more than half a period duration of a mains alternating voltage.

23. The induction energy supply device of claim 14, wherein the control unit is designed, during the interruption time window, aside from an interaction with the communication unit, to carry out at least one further operation.

24. The induction energy supply device of claim 23, wherein the further operation comprises a detection of a foreign object in a vicinity of the supply induction element.

25. The induction energy supply device of claim 14, wherein the placeable unit is designed as a small household appliance.

26. The induction energy supply device of claim 14, wherein the placeable unit is designed as a cooking equipment item.

27. A method for operating an induction energy supply device, the method comprising:
inductively supplying energy to a placeable unit by a supply induction element;
driving the supply induction element by an inverter unit;
providing a wireless communication with the placeable unit; and
interrupting an operation of the inverter unit at regular intervals during an interruption time window for the wireless communication.

28. The method of claim 27, wherein the operation of the inverter unit is interrupted at periodic intervals during the interruption time window for the wireless communication.

29. The method of claim 27, further comprising extending a duration of the interruption time window for reducing the inductively provided energy.

30. The method of claim 27, further comprising spacing successive interruption time windows temporally by at least a half period duration of a mains alternating voltage.

31. The method of claim 27, further comprising operating the inverter unit during a transition time window at an adjusted frequency compared with a target power frequency.

32. The method of claim 31, further comprising arranging the transition time window and the interruption time window temporally immediately adjoining one another.

3. The method of claim 27, further comprising, during the interruption time window, aside from an interaction with the communication unit, carrying out at least one further operation for detection of a foreign object in a vicinity of the supply induction element.
